(19) United States
(12) Patent Application Publication
(10) Pub. No.: US 2002/0023150 A1
(43) Pub. Date: Feb. 21, 2002

(54) Method of switching between network interfaces and computer connectable to a network

(76) Inventors: Tatsuaki Osafune, Yokohama (JP); Katsuyoshi Kitai, Inagi (JP)

Correspondence Address: Stanley P. Fisher, Reed Smith Hazel & Thomas LLP, Suite 1400, 3110 Fairview Park Drive, Falls Church, VA, 22042-4503, US

(21) Appl. No.: 09/892,726

(22) Filed: Jun. 28, 2001

(30) Foreign Application Priority Data
Aug. 9, 2000 (JP) 2000-247904

(51) Int. Cl. G06F 15/177

(52) U.S. Cl. 709/221; 709/227

(57) ABSTRACT

An apparatus and method for changing over from an active network interface (NIF) to its standby NIF. The network system configuration may include at least two server computers, each having active and standby NIFs, the active NIF connected to first communication equipment and the standby NIF connected to second communication equipment. Both the first communication equipment and the second communication equipment are connected to a router. When at least one server computer detects a fault occurring in the path between its active network interface and the router, the server computer changes the IP address assignment from its active NIF to its standby NIF. Then, the server computer transmits an ARP request from its standby NIF to the router in order to make the router change the MAC address registration mapped to the above IP address, retained in the ARP cache of the router, from the MAC address assigned to its active NIF to the MAC address assigned to its standby NIF.

### PRIORITY TO FOREIGN APPLICATIONS

This application claims priority to Japanese Patent Application No. P2000-247904.

### BACKGROUND OF THE INVENTION

1. Field of the Invention

The present invention relates to network systems, and more particularly, the present invention relates to devices and methods for network systems of redundant configuration.

2. Description of the Background

A method of switching between duplicated communication adapters is disclosed in JP-A-320327/1998. This switching method is explained below with reference to FIG. 12. A host X10 is connected to a LAN X100 via duplicated communication adapters X11 and X12. Although both communication adapters X11 and X12 always operate as networking entities, the host X10 normally performs communication, exclusively using the communication adapter X1, while the other communication adapter X12 is placed in the standby state. Another host X20 is connected to the LAN X100 via a communication adapter X21, and furthermore, another LAN X200 is linked thereto via a router X30. Computers X210 and X220 are connected to the LAN X200.

The host X10 has an ARP (Address Resolution Protocol) cache X10a that retains the mapping between IP addresses and MAC (Media Access Control) addresses. If the host X10 detects a fault of the communication adapter X11, it carries out standby hardware allocation. Specifically, in order to use the communication adapter X12 for backup as the substitute for the communication adapter X1, the host X10 sends a request to be active to the communication adapter X12. When the host X10 receives a response to the request, indicating the completion of activation, from the communication adapter X12, it updates its ARP cache X10a and changes the MAC address from a to c.

The host X10 looks for the destination node that it now communicates with in the same network. Then, the host X10 transmits an ARP response message to the other node of communication across the network to prompt the node to update its local ARP cache. When, for example, the communication adapter X21 of the host X20 receives this ARP response message, the host X20 registers the MAC address c mapped to the IP address A into its ARP cache and the on-going communication continues.

In JP-A-321825/1995, a multiple network control system is disclosed. This system is explained below with reference to FIG. 13. Computers Y1a and Y1b, respectively, have application programs Y2a and Y2b installed therein and network controllers Y3a and Y3b.

The application programs Y2a use the network controller Y3a to access a network Y6, and the application programs Y2b use the network controller Y3b to access a network Y7. The network controller Y3a is equipped with a routing controller Y10a that controls communication path setup based on a routing control table Y11a. Similarly, the network controller Y3b is equipped with a routing controller Y10b that controls communication path setup based on a routing control table Y11b. Network interfaces Y4a and Y5a are for the network Y6 and network interface Y4b and Y5b are for the network Y7.

The computer Y1a includes a selector Y9a that functions to rewrite the communication control data part of the communication data that was attempted to be transmitted across a network placed under fault conditions and transmit the data across a properly operating network.

Similarly, the computer Y1b includes a selector Y9b that functions in the same way as the selector Y9a does. The network controllers Y3a and Y3b can handle the selectors Y9a and Y9b respectively in the same way as they use their network interfaces. Thus, multiple network control systems Y8a and Y8b are realized by adding the selectors Y9a and Y9b without changing the network controllers Y3a and Y3b.

The selectors Y9a and Y9b, respectively, use ARP request recording tables Y12a and Y12b which are prepared for each network interface. Moreover, the selectors Y9a and Y9b, respectively, use ICMP echo reply recording tables Y13a and Y13b which are prepared for each network interface.

The operation of each multiple network control system configured as described above will now be explained. When the computer is transmitting an IP packet, the selector searches the echo reply recording table for a match with the key of the destination IP address of the packet. If the search is successful, i.e., the destination IP address is located in the table, the IP packet is transmitted to that address via the network interface. If the search is unsuccessful, the hardware address registration of the IP address is deleted from the ARP table. Then, an ICMP echo request frame is issued to the normally operating network interface. If a reply to the request occurs within a given time, it is registered into the echo reply recording table and the IP frame is delivered to the normally operating network interface.

Unless the reply occurs within that given time, the ICMP echo request frame is issued to the other network interface. If a reply from the other network interface occurs (is received) within a given time, it is registered into the echo reply recording table and the IP packet is delivered to this network interface. If neither of the network interfaces replies to the request, the IP frame is discarded.

The related art disclosed in the JP-A-320327/1998 is not useful for coping with the fault of the LAN X100. The related art disclosed in the JP-A-321825/1995, on the other hand, may allow the on-going communication to continue even under network fault conditions, for example, if the fault of the network Y6 occurs. However, the destination node that the source node is communicating with must be connected to the same network and operate with the same capability of switching between duplicated communication adapters as the source node does. All possible destination addresses that the source node may communicate with are recorded in the ICMP echo reply recording table and when an IP packet is transmitted, this table is searched for a look-up for the specified destination address of the packet. As the number of the destination addresses increases, the processing time for the search also increases.

### SUMMARY OF THE INVENTION

In a highly-reliable network system in accordance with the present invention, even if equipment and a line in the network are placed in a fault state, automatic communication restoration can be achieved by the switchover between the paths and the NIFs. The present invention enables the building of such a network system with high reliability.

In one presently preferred embodiment of the invention, a network system configuration is provided that includes at least two server computers, each having active and standby network interfaces, wherein the active network interface is connected to first communication equipment and the standby network interface is connected to second communication equipment. Both the first communication equipment and the second communication equipment are connected to a router.

When at least one server computer detects that a fault occurred in the path between its active network interface and the router, the server computer removes (changes) the IP address assignment from its active network interface to its standby network interface. Then, the server computer transmits an ARP request from its standby network interface to the router in order to make the router change the MAC address registration mapped to the above IP address, retained in the ARP cache of the router, from the MAC address assigned to its active network interface to the MAC address assigned to its standby network interface.

When at least one server computer receives a network interface switching request packet from another server computer, the server computer removes (changes) the IP address assignment from its active network interface to its standby network interface. Then, the server computer transmits an ARP request from its standby network interface to the router in order to make the router change the MAC address registration mapped to the above IP address, preferably retained in the ARP cache of the router, from the MAC address assigned to its active network interface to the MAC address assigned to its standby network interface.

Other and further objects, features and advantages of the invention will appear more fully from the following description, drawings, and attached claims.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a diagram showing a network system configuration for explaining a first preferred embodiment of the present invention;

FIG. 2 is a diagram exemplifying those components provided in a client computer that may be utilized to embody the invention;

FIG. 3 is a diagram exemplifying those components provided in a router that may be utilized to embody the invention;

FIG. 4 is a diagram exemplifying those components provided in a server computer that may be utilized to embody the invention;

FIG. 5 is a monitoring process flowchart;

FIG. 6 is a diagram exemplifying data items and data contents retained within the monitoring process;

FIG. 7 is a diagram for explaining router operation;

FIG. 8 is a diagram showing the frame format of a network interface switching request packet;

FIG. 9 is a flowchart illustrating a network interface switching request acceptance process;

FIG. 10 is a diagram showing another network system configuration for explaining a second preferred embodiment of the present invention;

FIG. 11 is a flowchart of the monitoring process wherein automatic finding of echo request destinations is performed;

FIG. 12 is a diagram showing a conventional communication network with duplicated communication adapters; and

FIG. 13 is a block diagram showing a conventional system configuration with computers each having a multiple network control system.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings.

### EMBODIMENT 1 EXAMPLES

### System Configuration

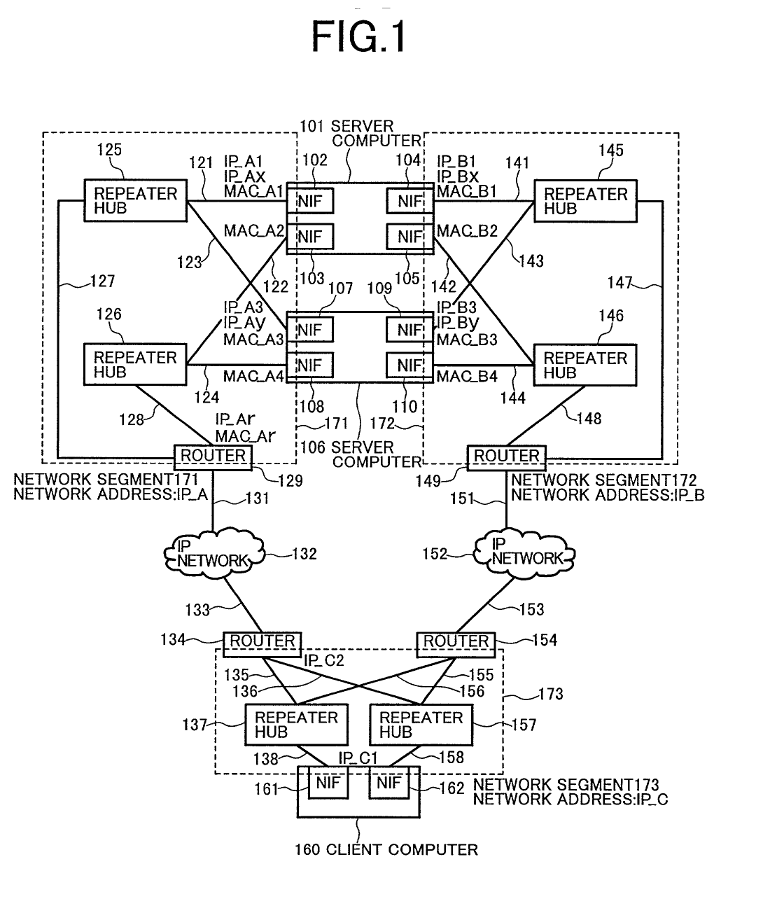

FIG. 1 is a diagram showing a network system configuration according to a first preferred embodiment (embodiment 1) of the present invention. In embodiment 1, the communication paths are symmetrically duplicated. During normal operation, the left network portion, more specifically, a network segment 171 and an IP network 132, are used for communication. If communication cannot be performed, using the left network portion, the right network portion is preferably used for communication. Whether or not the network system includes the right network potion depends on whether or not the network users want higher reliability.

Network interfaces (NIFs) 102 and 103 are mounted on a server computer 101. The NIFs 102 and 103 are connected to the network segment 171. The NIF 102 is an active network interface that is normally used for communication, whereas the NIF 103 is a standby network interface that is normally out of service (not used) for communication but is used if the communication with the NIF 102 is judged impracticable. NIFs 104 and 105 are also mounted on the server computer 101. The NIFs 104 and 105 are connected to a network segment 172, the NIF 104 being an active network interface and the NIF 105 being a standby network interface. The network segment 171 and the network segment 172 are preferably not the same.

On another server computer 106, NIFs 107 and 108 are mounted. The NIFs 107 and 108 are connected to the network segment 171, the NIF 107 being an active network interface and the NIF 108 being a standby network interface. NIFs 109 and 110 are also mounted on the server computer 106. The NIFs 109 and 110 are connected to the network segment 172, the NIF 109 being an active network interface and the NIF 110 being a standby network interface.

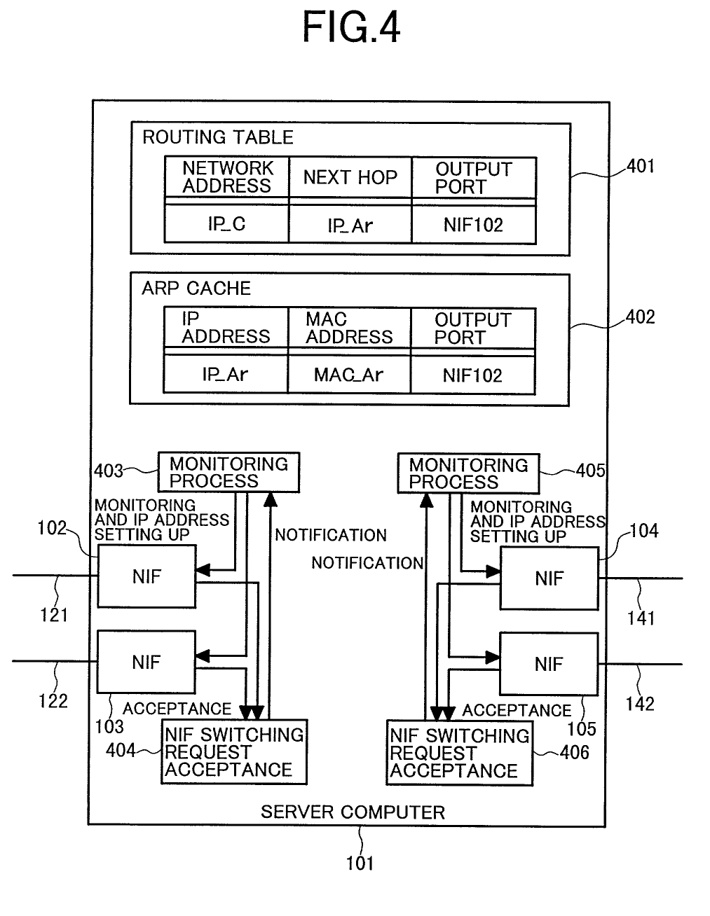

Although only two server computers are shown in the drawing of embodiment 1, it will be evident from the following description of the invention that the number of server computers is not limited to two. Additionally, a server computer that does not have all of the functionality that will be described with respect to FIG. 4 may be connected to the network segment 171 in addition to or in place of the server computers 101 and 106. The function of server computers 101 and 106 will be described at a later point in the description.

The NIF 102 is preferably connected to a repeater hub 125 with a LAN cable 121, and the NIF 103 is connected to a repeater hub 126 with a LAN cable 122. The NIF 107 is connected to the repeater hub 125 with a LAN cable 123, and the NIF 108 is connected to the repeater hub 126 with a LAN cable 124. The repeater hubs 125 and 126 are connected to a router 129 by LAN cables 127 and 128, respectively. The router 129 preferably operates to bridge the LAN cables 127 and 128. The router 129 is connected to a router 134 through a line 131, an IP network 132, and a line 133.

The NIF 104 is preferably connected to a repeater hub 145 with a LAN cable 141, and the NIF 105 is connected to a repeater hub 146 with a LAN cable 142. The NIF 109 is connected to the repeater hub 145 with a LAN cable 143, and the NIF 110 is connected to the repeater hub 146 with a LAN cable 144. The repeater hubs 145 and 146 are preferably connected to a router 149 with LAN cables 147 and 148, respectively. The router 149 operates to bridge the LAN cables 147 and 148. The router 149 is connected to a router 154 through a line 151, an IP network 152, and a line 153.

The router 134 is connected to a repeater hub 137 with a LAN cable 135 and to a repeater hub 157 with a LAN cable 136. The router 154 is connected to the repeater hub 137 with a LAN cable 156 and to the repeater hub 157 with a LAN cable 155.

NIFs 161 and 162 are preferably mounted on a client computer 160. The NIF 161 is an active network interface and the NIF 162 is a standby network interface.

The NIF 161 is connected to the repeater hub 137 with a LAN cable 138, and the NIF 162 is connected to the repeater hub 157 with a LAN cable 158.

Routing protocol transmission to and reception from each other are carried out between: the server computer 101 and the router 129; the server computer 101 and the router 149; the router 129 and the IP network 132; the router 149 and the IP network 152; the IP network 132 and the router 134; the IP network 152 and the router 154; and the router 134 and the router 154. For routing protocol transmission and reception, the server computer 101, the router 129, the router 149, the router 134, and the router 154 may have the information for forwarding packets to the network segment 171, 172, or 173 retained on their routing table.

Network IP address IP_A is assigned to the network segment 171, network IP address IP_B to the network segment 172, and network IP address IP_C to the network segment 173. To the NIF 102, IP addresses IP_A1 and IP_Ax and MAC address MAC_A1 are assigned. To the NIF 103, MAC address MAC_A2 is assigned. To the NIF 104, IP addresses IP_B1 and IP_Bx and MAC address MAC_B1 are assigned. To the NIF 105, MAC address MAC_B4 is assigned. To the NIF 107, IP addresses IP_A3 and IP_Ay and MAC address MAC_A3 are assigned. To the NIF 108, MAC address MAC_A4 is assigned. To the NIF 109, IP addresses IP_B3 and IP_By and MAC address MAC_B3 are assigned. To the NIF 110, MAC address MAC_B4 is assigned. To the NIF 161, IP address IP_C1 is assigned. The router 154 is a hot standby for the router 134, preferably using a Virtual Router Redundancy Protocol (VRRP). The routers 134 and 154 share the one IP address IP_C2, the router 134 being active and the router 154 being standby.

The communication method, using the left network portion only as an example, will be explained below. The right network portion preferably functions in the same manner as the left network potion.

### Normal Packet Transmission

A normal packet transmission procedure will now be explained. In a first exemplary case, in which no fault is occurring, the client computer 160 transmits a packet to the destination IP address that is the IP address IP_A1 assigned to the server computer 101 (discussed below).

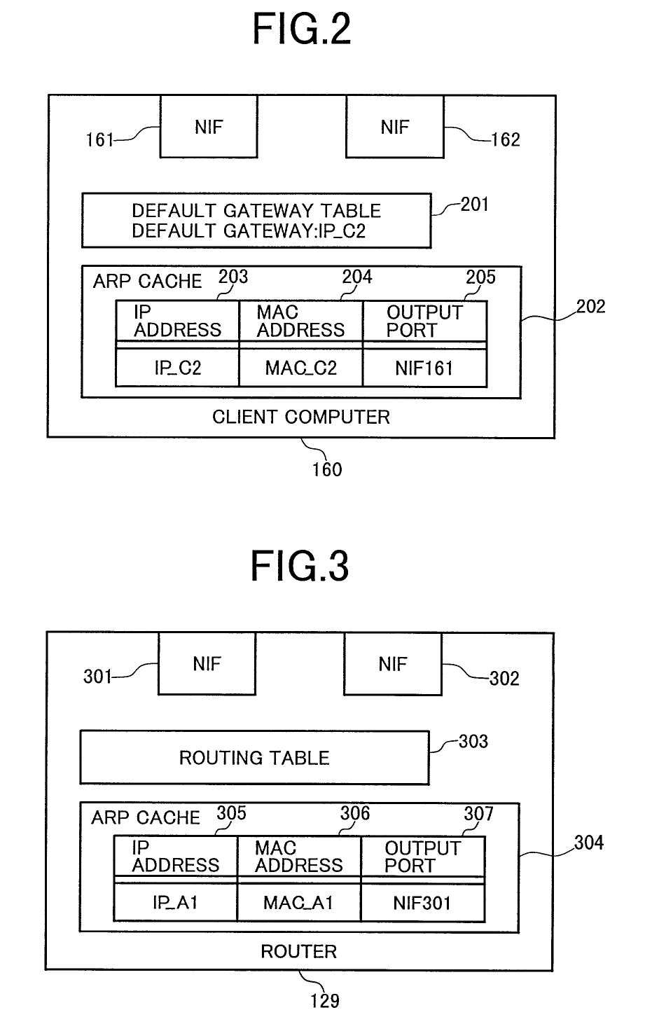

FIG. 2 is a diagram detailing those components provided in the client computer 160 that are preferably utilized in this example. The client computer retains a default gateway table 201. An ARP cache 202 retains MAC addresses mapped to IP addresses. The default gateway table and the ARP cache preferably reside in the memory of the client computer. The ARP cache 202 may retain IP address 203, MAC addresses 204 mapped to the IP address, and output port 205 for the IP address. In FIG. 2, exemplary entries of the table and the cache are given: the IP address IP_C2 is registered as the default gateway address in the default gateway table 201; and the IP address IP_C2, the MAC address MAC_C2 mapped to the IP address IP_C2, and the output port NIF 161 for routing packets to the IP address are registered in the ARP cache 202.

By referring to the default gateway table 201, the client computer 160 finds that the default gateway address is IP_C2. Then, the computer searches the ARP cache 202 and finds that the MAC address mapped to the IP_C2 is MAC_C2 and the output port is the NIF 161. The client computer 160 sets MAC_C2 for the destination MAC address of a packet and transmits the packet from its NIF 161. The routers 134 and 154 receive this packet. Because it is active, the router 134 preferably forwards the received packet in accordance with its routing table. However, the router 154, because it is in standby, discards the received packet. The packet forwarded from the router 134 arrives at the router 129 across the IP network 132.

FIG. 3 is a diagram detailing those components provided in the router 129 that are preferably utilized in this example. This diagram comprises NIFs 301 and 302 mounted on the router, a routing table 303 and an ARP cache 304. The ARP cache 304 retains IP address 305, MAC address 306 mapped to the IP address, and output port 307 for the IP address. The routing table 303 and the ARP cache 304 preferably reside in the memory of the router. Upon the reception of the above packet with its destination IP address of IP_A1, the router 129 searches the ARP cache 304 and finds that the MAC address mapped to the IP_A1 is MAC_A1 and the output port is the NIF 301. The router 129 sets MAC_A1 for the destination MAC address of the packet and transmits the packet from its NIF 301. The packet arrives at the NIF 102 to which the MAC address MAC_A1 is assigned and the server computer 101 thus receives it.

In a second exemplary case, in which no fault is occurring, the server computer 101 transmits a packet to the client computer 160. This case is now described below.

FIG. 4 is a diagram detailing those components provided in the server computer 101 that are preferably utilized in this exemplary embodiment. The server computer 101 has at least one microprocessor and a memory which are not shown and an operating system (OS) which is not shown installed therein. A routing table 401 and an ARP cache 402 preferably reside on the memory of the server computer 101. A monitoring process 403 monitors the NIFs 102 and 103 to detect a fault occurring and to perform switching between the NIFs when such a fault is detected. A NIF switching request acceptance process 404 accepts a packet including a request for NIF switching, and, if the NIF 102 or 103 receives this packet from another computer, the process 404 notifies the monitoring process 403 of this request.

A monitoring process 405 monitors the NIFs 104 and 105 to detect a fault occurring and performs switching between the NIFs when a fault occurs. A NIF switching request acceptance process 406 accepts a packet of request for NIF switching, and, if the NIF 104 or 105 receives this packet from another computer, it notifies the monitoring process 405 of this request. The monitoring processes 403 and 405 and the NIF switching request acceptance processes are preferably executed by the microprocessor. The server computer 106 preferably has the same structure as shown in FIG. 4.

When transferring a packet to the IP address IP_C1 assigned to the client computer 160, the server computer 101 searches the routing table 401. Therein, the server finds that the next hop IP address mapped to the network address IP_C corresponding to the IP address IP_C1, that is, the IP address of the next network node to which the packet is to be forwarded is IP_Ar, and the output port is the NIF 102. Next, the server 101 searches the ARP cache 402 and finds that the MAC address mapped to the IP_Ar is MAC_Ar. The server 101 sets MAC_Ar for the destination MAC address of the packet and transmits the packet from its NIF 102.

The router 129 acknowledges the match of the destination MAC address of the packet with its MAC address MAC_Ar, receives the packet, and forwards the packet in accordance with the routing table it retains. The packet forwarded from the router 129 arrives at the router 134 across the IP network 132. Because the destination IP address of the packet is IP_C1, the router 134 searches the ARP cache it retains for the MAC address mapped to the IP address IP_C1. Then, the router 134 assigns the searched out MAC address as the destination MAC address to the packet and transmits the packet. The client computer 160 acknowledges the match of the destination MAC address of the packet with its MAC address and receives the packet.

### Packet Transmission for Communication in the Event of a Fault Occurring

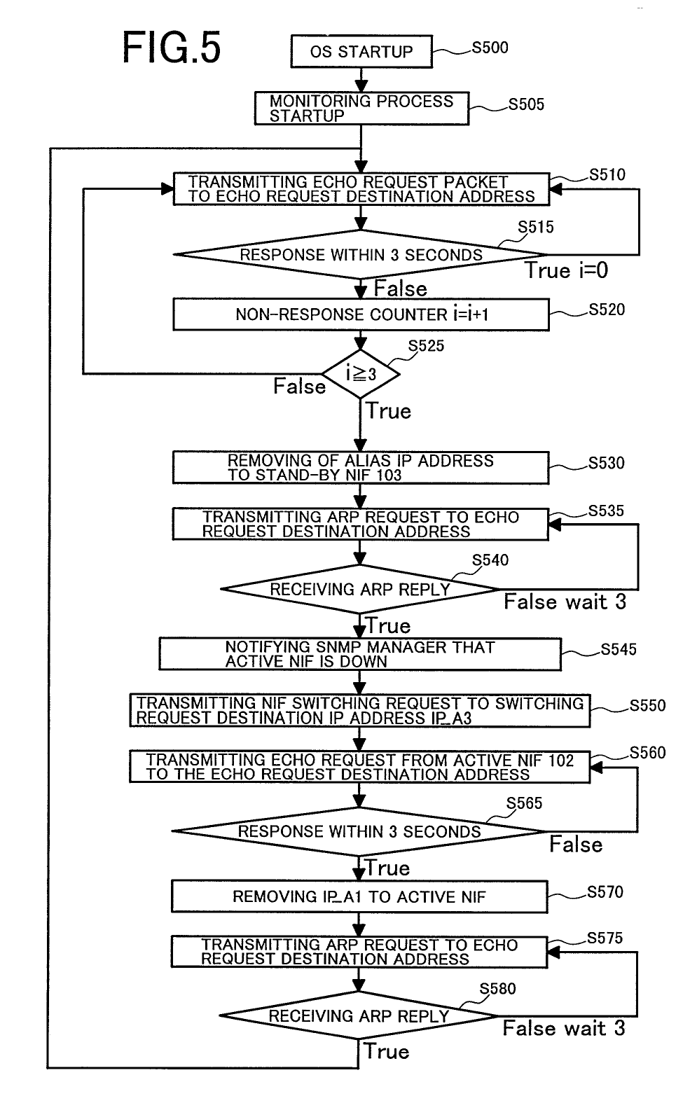

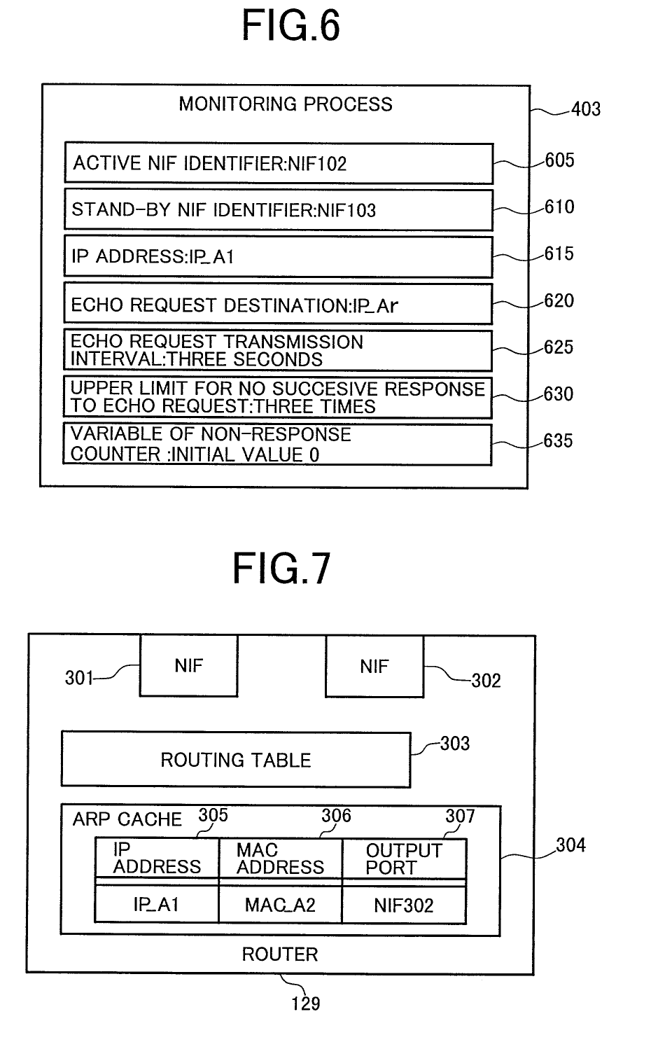

By way of example, it is now assumed that a fault in the LAN cable 121 has occurred, and an exemplary embodiment that keeps the communication from disruption in this condition is explained below. When such a fault occurs, the monitoring process 403 operating on the server computer 101 preferably detects the fault and removes (changes) the IP address IP_A1 assignment from the NIF 102 to the NIF 103. This network interface switchover processing flow is explained below with reference to FIG. 5 and FIG. 6.

For the convenience of explanation, this discussion initially refers to FIG. 6. FIG. 6 details data items and data contents retained within the monitoring process 403. As the active NIF identifier 605, NIF 102 is registered. As the standby NIF identifier 610, NIF 103 is registered. As the IP address 615 assigned to the active NIF 102 or the standby NIF 103, IP_A1 is registered. As the echo request destination 620, IP_Ar is registered. As the echo request transmission interval 625, an interval of 3 seconds is registered, which is selected for the first exemplary embodiment. As the upper limit for no successive responses to echo request 630 (e.g., successive times a response is not received), a limit of three times is registered. As the variable of non-response counter 635, an initial value of 0 is set. The settings of these data items can preferably be changed by the user.

FIG. 5 is a flowchart of the monitoring process 403. When the power of the server computer 101 is turned ON, the OS starts up (step S500) and the IP address IP_A1 is assigned to the active NIF 102. The present monitoring process 403 starts up (step S505). From the NIF 102, an Internet Control Message Protocol (ICMP) echo request is transmitted to the address IP_Ar that is set for the echo request destination 620 (step S510). A determination is made as to whether the NIF has received a response to the echo request within a given time (step S515). Because the echo request transmission interval 625 is set at 3 seconds in the case of this first embodiment, three seconds are preferably allowed to pass before receiving a response to the echo request. If the NIF receives a response to the echo request within three seconds, the non-response counter 635 is set to 0, and the processing returns to the step S510.

Unless the NIF receives a response to the echo request within three seconds, the non-response counter 635 is incremented by one (step S520). A determination is made as to whether the value of the non-response counter 635 has reached the count of three that is set as the upper limit for no successive responses to echo request 630 (step S525). If the value of the non-response counter 635 is less than three, the processing returns to the step 510. If the value of the non-response counter 635 has reached the count of three (or whatever the set value is), the monitoring process preferably determines that a network fault has occurred and attempts to remove the IP address IP_A1 assignment from the active NIF 102 to the standby NIF 103.

IP_A1 is assigned to the standby NIF 103 (step S530). From the standby NIF 103, an ARP packet for MAC address inquiry with the request source IP address of IP_A1 is transmitted to the address IP_Ar that is set for the echo request destination 620 (step S535). This ARP packet transmission is to confirm the connection to the router 129 with the IP address IP_Ar and to rewrite the ARP cache 304 that the router 129 retains. As the result of this rewrite, the written contents of the ARP cache 304 of the router 129 will be IP_A1, MAC address MAC_A1 of the standby NIF 103 as the MAC address mapped to the IP_A1, and NIF 302 as the output port as will be given in FIG. 7.

Then, a determination is made as to whether the NIF has received an ARP reply (step 540). If the NIF receives no ARP reply, the processing returns to the step S535. If the NIF has received an ARP reply, it is determined that the connection to the IP_Ar set for the echo request destination 620 has been confirmed. The server 101 sends the Simple Network Management Protocol (SNMP) manager that has been set up beforehand a packet for the message that the active NIF has gone down (not used because of a failure) (step S545). The server computer 101 transmits a NIF switching request to the destination of the IP address IP_A3 assigned to the NIF 107 of the server computer 106 (step S550). The step S550 will be further explained below.

In this state, when the client computer 160 transmits a packet with the destination IP address of IP_A1, the packet arrives at the router 129 as it does under normal operating condition. Because the written contents of the ARP cache 304 of the router 129 are IP_A1, MAC_A2 as the MAC address mapped to the IP_A1, and NIF 302 as the output port, which are different from the contents set in normal operating condition, the router 129 preferably changes the destination MAC address of the packet to MAC_A2 and transmits the packet from its NIF 302. The packet passes through the LAN cable 128, the repeater hub 126; and the LAN cable 122 and arrives at the NIF 103, and thus the server computer 101 can receive this packet.

When the server computer 101 is attempting to transmit a packet to the client computer 160, it transmits the packet from its NIF 103. The packet follows the above route in the reverse direction and arrives at the router 129. Then, the router 129 transmits the packet to the client computer 160 in the same way as in normal operating condition. Therefore, the server computer 101 and the client computer 160 can communicate with each other.

In the event of the fault of the repeater hub 126 or the LAN cable 128, the same operation for NIF switchover as for the fault of the LAN cable 122 can keep the communication continuing.

After the monitoring process 403 removes (changes) the IP_A1 assignment to the standby NIF 103 as described above, the server computer 101 communicates with the client computer 160, using the standby NIF 103. At the same time, the monitoring process 403 continues monitoring in order to remove again the IP address IP_A1 to the active NIF 102 after the restoration of the communication path from the active NIF 102 to the IP_Ar that is set for the echo request destination 620. From the active NIF 102, an echo request is transmitted to the IP_Ar that is set for the echo request destination 620 by using IP_Ax (step 560). A determination is made as to whether the NIF has received a response to the echo request (step S565). If the NIF has received no response after the elapse of three seconds, the processing returns to the step S560.

Therefore, prior to the recovery from the fault of the LAN cable 121, the steps S550 and S560 are repeated. If the NIF has received the response, it is determined that the network has recovered from the fault, and the IP address IP_A1 is removed to the active NIF 102 (step S570). From the active NIF 102, an ARP request is transmitted to the IP_Ar that is set for the echo request destination 620 (step S575). If the NIF has received an ARP reply, the processing goes back to the step S510 (step S580). In this way, after the recovery from the fault of the LAN cable 121, the IP address IP_A1 assignment is automatically removed from the standby NIF 103 to the active NIF 102 and the communication using the active NIF 102 resumes.

If only the fault of the LAN cable 121 occurs, the server computer 106 can continue the on-going communication by continuing to use its active NIF 107. However, it is possible that the fault of the repeater 125 or the router 129 occurs at the same time as the fault of the cable 121. In the first exemplary embodiment, thus, the NIF switching request is transmitted to the IP address IP_A3 assigned to the server computer 106 in the step S550, and the server computer 106 performs the switching over from the active NIF to the standby NIF. This switching procedure will be explained below.

On the server computer 101, IP_A3 has been registered in advance as the switching request destination IP address. The server computer 101 transmits a NIF switching request packet with the source IP address of IP_A1 to the destination IP address IP_A3 from its NIF 103.

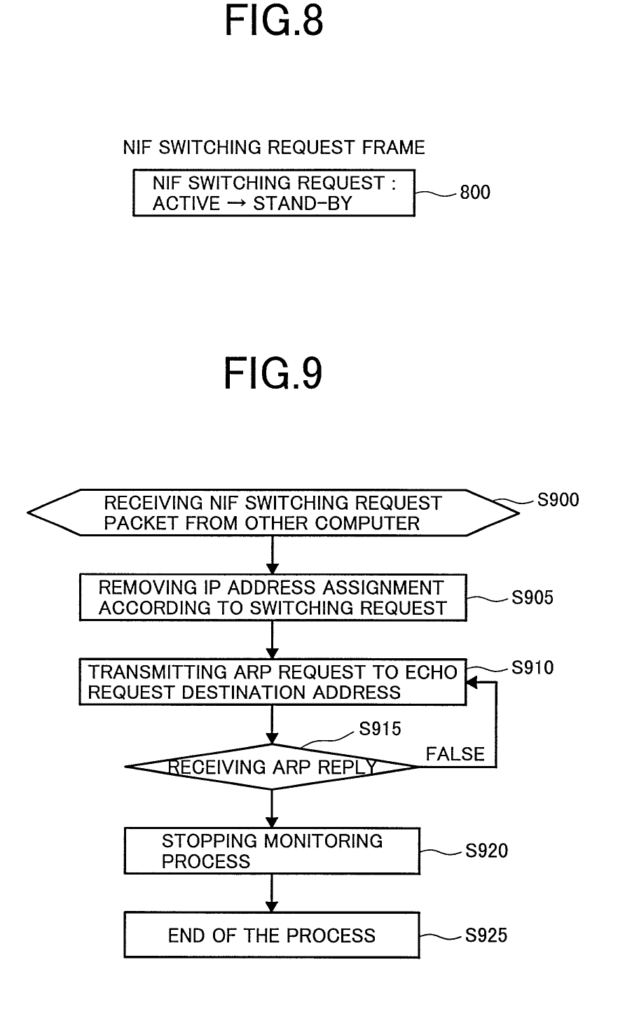

A preferable frame format of the NIF switching request packet is shown in FIG. 8. The NIF switching request frame 800 contains a description of a request for switching over from the active NIF to the standby NIF.

The packet passes through the LAN cable 122, the repeater hub 126, the LAN cable 128, the router 129, the LAN cable 127, the repeater hub 125, and the LAN cable 123 (in that order), and arrives at the NIF 107. The packet that arrived at the NIF 107 is received by the NIF switching request acceptance process installed in the server computer 106.

The operation of the NIF switching request acceptance process is illustrated in FIG. 9. The process receives the NIF switching request packet (step S900). The IP address assignment is removed in accordance with the switching request (step S905). In the embodiment 1 configuration, the IP address IP_A3 is removed from the NIF 107 to the NIF 108. An ARP request is transmitted to the echo request destination address (step S910). If no ARP reply is received, the processing returns to the step S910 (step S915). If an ARP request has been received, the processing goes to step S920 where the monitoring process stops, and the present processing terminates in step S925. If the ARP reply has been received in the step S915, the ARP cache 304 of the router 129 is updated such that the MAC address mapped to the IP address IP_A3 is rewritten from MAC_A3 to MAC_A4.

As described above, the request for switchover from the active NIF to the standby NIF is transmitted from the server computer 101 to the server computer 106, and in accordance with this request, the server computer 106 removes (changes) the IP address IP_A3 assignment from the active NIF 107 to the standby NIF 108. As a result, the server computer 101 and the server computer 106 can continue to communicate with each other, using the IP address IP_A1 of the former and the IP address IP_A3 of the latter, even if the fault of the repeater hub 125 or the router 129 occurs, following the fault of the LAN cable 121.

When the network interface of the server computer 101 is switched from the standby NIF 103 to the active NIF 102, the network interface of the server computer 106 is also switched from the standby NIF 108 to the active NIF 107 by following the same flow as illustrated in FIG. 9.

### EMBODIMENT 2 EXAMPLES

While the description according to embodiment 1 discussed as an example the case where an echo request destination address is specified, a second preferred embodiment (embodiment 2) of the invention, wherein servers and routers exchange routing information by using the routing protocol and automatically find echo request destinations, will be explained below.

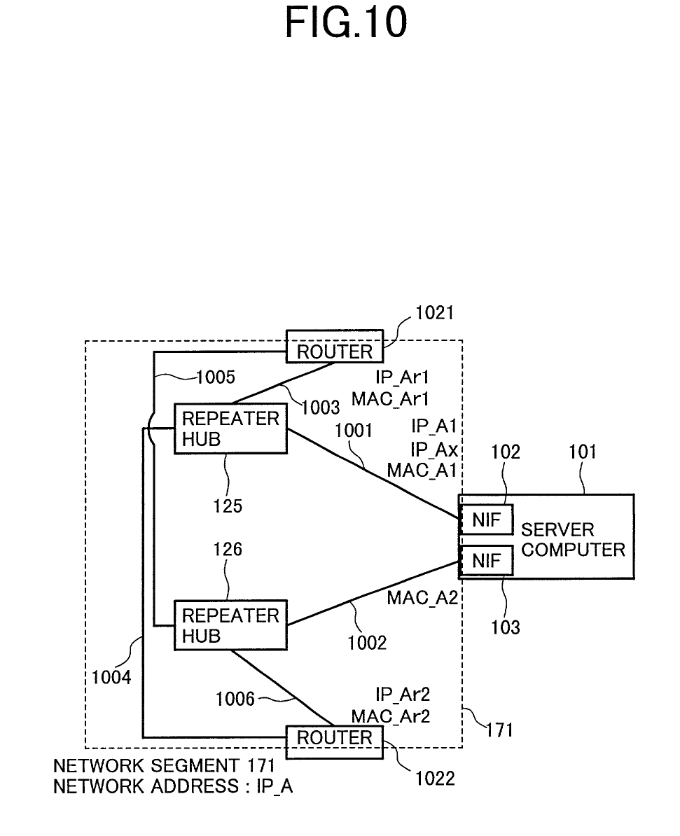

FIG. 10 is a diagram showing a network system configuration for explaining a second series of examples in accord with the present invention. Although FIG. 10 shows only the server computer 101 and the network segment 171 extracted from the entire network system configuration, in fact, the server computer 106 is also preferably connected to the repeater hubs 125 and 126 as in FIG. 1. The configuration shown in FIG. 10 differs from the configuration shown in the first embodiment in that two routers are connected to the network segment 171. The active NIF 102 of the server computer is connected to the repeater hub 125 with a LAN cable 1001, and the standby NIF 103 is connected to the repeater hub 126 with a LAN cable 1002. The repeater hub 125 is connected to a router 1021 with a LAN cable 1003 and to a router 1022 with a LAN cable 1004. The repeater hub 126 is connected to the router 1021 with a LAN cable 1005 and to the router 1022 with a LAN cable 1006. The router 1021 operates to bridge two LAN cables 1003 and 1005, and the router 1022 operates to bridge two LAN cables 1004 and 1006.

IP address IP_Ar1 and MAC address MAC_Ar1 are assigned to the router 1021. IP address IP_Ar2 and MAC address MAC_Ar2 are assigned to the router 1022. The server computer 101 and the routers 1021 and 1022 preferably exchange routing information using the routing protocol.

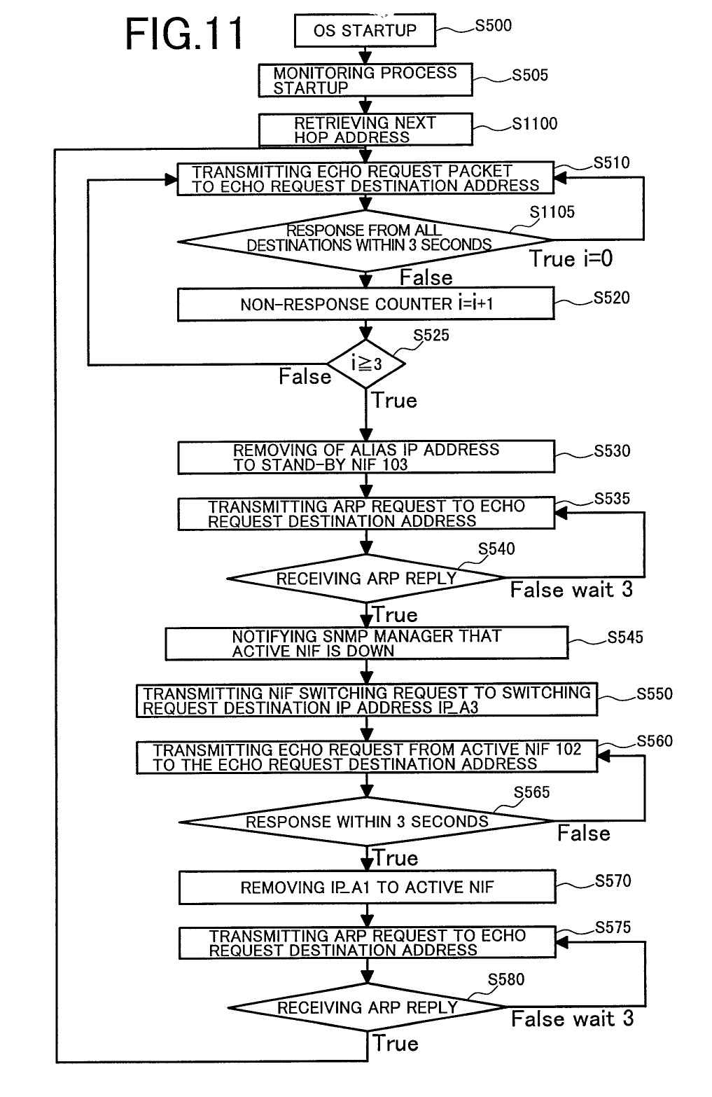

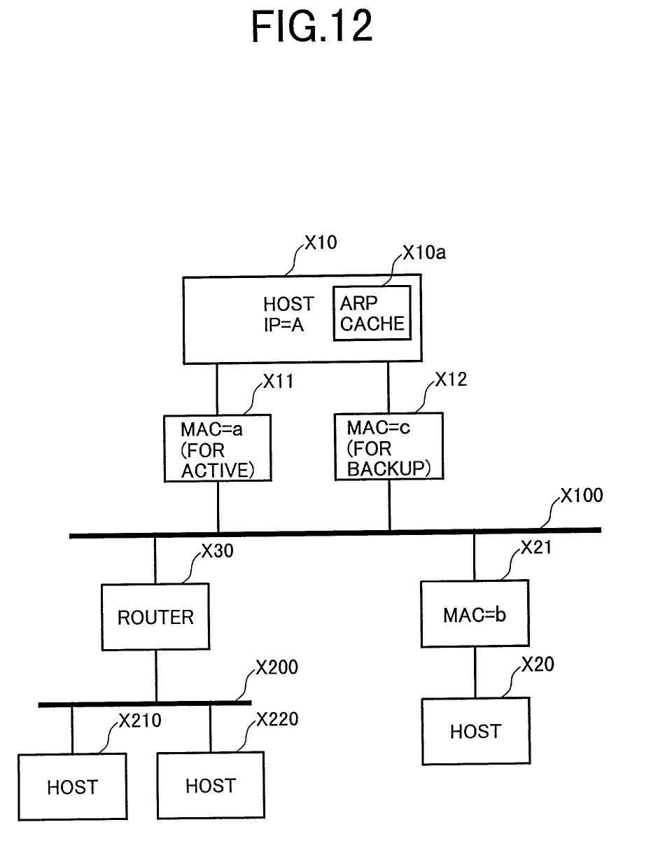

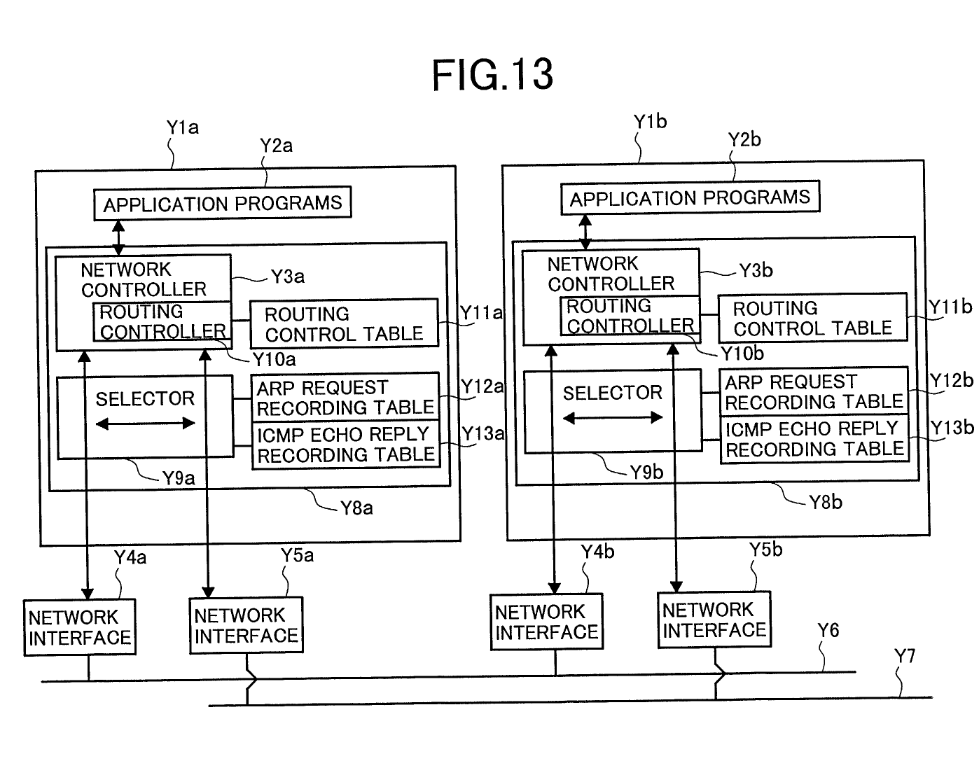

As is the case in the first embodiment, the monitoring process is preferably installed in the server computer 101. FIG. 11 is a flowchart of the monitoring process. This flowchart differs from the flow shown in FIG. 5 in that a step of retrieving the next hop address (step S1100) is added after the step S505 and that a step of awaiting responses from all echo request destinations (step S1105) replaces the step S515. The server retrieves the next hop address from its routing table and sets the retrieved next hop addresses to be the addresses of echo request destinations. In the second embodiment, the IP address IP_Ar1 of the router 1021 and the IP address IP_Ar2 of the router 1022 are retrieved. By thus retrieving the next hop addresses, the server can automatically find echo request destinations if the server performs routing information exchange by using the routing protocol. Action that follows this address retrieval is the same as in the examples of the first embodiment; i.e., echo request is transmitted to IP_Ar1 and IP_Ar2 and if the server receives no response from both, switching over from the active NIF 1002 to the standby NIF 1003 is performed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. A method of switching between network interfaces of a computer, said computer having an active network interface connected to a router via first networking equipment and a standby network interface connected to said router via second networking equipment, said first networking equipment also connected to an active network interface of another computer, and said second networking equipment also connected to a standby network interface of said another computer, said method comprising the steps of:
detecting a fault occurring in a path between said active network interface of said computer and said router;
changing an Internet Protocol (IP) address assignment from said active network interface of said computer to said standby network interface of said computer; and
transmitting an Address Resolution Protocol (ARP) request from said standby network interface of said computer to said router to make said router change a Media Access Control (MAC) address registration mapped to said IP address, retained in an APP cache of said router, from a MAC address assigned to said active network interface of said computer to a MAC address assigned to said standby network interface of said computer.

2. The method of switching between network interfaces of a computer as recited in claim 1, wherein said step of detecting a fault further comprises the steps of:
transmitting an echo request packet from said active network interface of said computer to said router; and
determining that a fault occurs in the path between said active network interface of said computer and said router if no response to said echo request packet takes place within a given time.

3. The method of switching between network interfaces of a computer as recited in claim 2, wherein said given time is preset, and further wherein said given time may be reset by a user during operation of the computer.

4. The method of switching between network interfaces of a computer as recited in claim 1, further comprising the step of:
transmitting a network interface switching request packet from said active network interface of said computer to a destination IP address assigned to said active network interface of said another computer in order to make said another computer change the IP address assignment from said active network interface of said another computer to said standby network interface of said another computer.

5. The method of switching between network interfaces of a computer as recited in claim 3, further comprising the step of:
transmitting a network interface switching request packet from said active network interface of said computer to a destination IP address assigned to said active network interface of said another computer in order to make said another computer change the IP address assignment from said active network interface of said another computer to said standby network interface of said another computer.

6. The method of switching between network interfaces of a computer as recited in claim 1, further comprising the steps of:
transmitting an echo request packet from said active network interface of said computer to said router after said changing step; and
changing again said IP address assignment from said standby network interface of said computer to said active network interface of said computer if a response to said echo request packet takes place within a given time after the execution of said step of removing the IP address assignment.

7. The method of switching between network interfaces of a computer as recited in claim 4, further comprising the steps of:
transmitting an echo request packet from said active network interface of said computer to said router after said changing step; and
changing again said IP address assignment from said standby network interface of said computer to said active network interface of said computer if a response to said echo request packet takes place within a given time after the execution of said step of removing the IP address assignment.

8. The method of switching between network interfaces of a computer as recited in claim 1, wherein both said first networking equipment and said second networking equipment are selected from the group consisting of repeater hubs and switching hubs.

9. The method of switching between network interfaces of a computer as recited in claim 6, wherein both said first networking equipment and said second networking equipment are selected from the group consisting of repeater hubs and switching hubs.

10. A method of switching between network interfaces of a computer, said computer having an active network interface connected to a router via first networking equipment and a standby network interface connected to said router via second networking equipment, said first networking equipment also connected to an active network interface of another computer, and said second networking equipment also connected to a standby network interface of said another computer, said method comprising the steps of:
receiving a network interface switching request packet from said another computer;
changing an IP address assignment from said active network interface of said computer to said standby network interface of said computer; and
transmitting an Address Resolution Protocol (ARP) request from said standby network interface of said computer to said router to make said router change a Media Access Control (MAC) address registration mapped to said IP address, retained in an ARP cache of said router, from a MAC address assigned to said active network interface of said computer to a MAC address assigned to said standby network interface of said computer.

11. The method of switching between network interfaces of a computer as recited in claim 10, wherein both said first networking equipment and said second networking equipment are selected from the group consisting of repeater hubs and switching hubs.

12. A computer connectable to a network, comprising:
an active network interface that is connected to a router via first networking equipment to which an active network interface of another computer is also connected, wherein said router includes an ARP cache which relates IP address registrations to MAC address registrations;
a standby network interface that is connected to said router via second networking equipment to which a standby network interface of said another computer is also connected; and
a processor for executing a process, wherein said process is capable of detecting a fault occurring in a path between said active network interface of said computer and said router, further wherein said process is capable of changing an IP address assignment from said active network interface of said computer to said standby network interface of said computer, and further wherein said process is capable of transmitting an Address Resolution Protocol (ARP) request from said standby network interface of said computer to said router to make said router change a Media Access Control (MAC) address registration mapped to said IP address, retained in an ARP cache of said router, from a MAC address assigned to said active network interface of said computer to a MAC address assigned to said standby network interface of said computer.

13. The computer connectable to a network as recited in claim 12, wherein said processor is capable of detecting a fault by transmitting an echo request packet from said active network interface of said computer to said router and determining that a fault occurs in the path between said active network interface of said computer and said router if no response to said echo request packet takes place within a given time.

14. The computer connectable to a network as recited in claim 13, wherein said given time is preset, and further wherein said given time may be reset by a user during operation of the computer.

15. The computer connectable to a network as recited in claim 12, wherein said processor is capable of transmitting a network interface switching request packet from said active network interface of said computer to a destination IP address assigned to said active network interface of said another computer in order to make said another computer change the IP address assignment from said active network interface of said another computer to said standby network interface of said another computer.

16. The computer connectable to a network as recited in claim 12, wherein said processor is capable of transmitting an echo request packet from said active network interface of said computer to said router after said changing step and changing again said IP address assignment from said standby network interface of said computer to said active network interface of said computer if a response to said echo request packet takes place within a given time after the execution of said step of removing the IP address assignment.

17. The computer connectable to a network as recited in claim 15, wherein said processor is capable of transmitting an echo request packet from said active network interface of said computer to said router after said changing step and changing again said IP address assignment from said standby network interface of said computer to said active network interface of said computer if a response to said echo request packet takes place within a given time after the execution of said step of removing the IP address assignment.

18. The computer connectable to a network as recited in claim 12, wherein both said first networking equipment and said second networking equipment are selected from the group consisting of repeater hubs and switching hubs.

19. A computer connectable to a network, comprising:
an active network interface that is connected to a router via first networking equipment to which an active network interface of another computer is also connected, wherein said router includes an ARP cache which relates IP address registrations to MAC address registrations;
a standby network interface that is connected to said router via second networking equipment to which a standby network interface of said another computer is also connected; and
a processor for executing a process, wherein said process is capable of receiving a network interface switching request packet from said another computer, further wherein said process is capable of changing an IP address assignment from said active network interface of said computer to said standby network interface of said computer, and further wherein said process is capable of transmitting an Address Resolution Protocol (ARP) request from said standby network interface of said computer to said router to make said router change a Media Access Control (MAC) address registration mapped to said IP address, retained in an ARP cache of said router, from a MAC address assigned to said active network interface of said computer to a MAC address assigned to said standby network interface of said computer.

20. The computer connectable to a network as recited in claim 19, wherein both said first networking equipment and said second networking equipment are selected from the group consisting of repeater hubs and switching hubs.
